(19) United States
(12) Patent Application Publication
(10) Pub. No.: US 2006/0064917 A1
(43) Pub. Date: Mar. 30, 2006

(54) JIG HOOK SETTING DEVICE

(76) Inventor: Chad Jonpaul Cakebread, LAKEMARY, FL (US)

Correspondence Address: CHAD JONPAUL CAKEBREAD, 35007 457 PLACE, AITKIN, MN, 56431, US

(21) Appl. No.: 10/711,614

(22) Filed: Sep. 28, 2004

(51) Int. Cl. A01K 91/10

(52) U.S. Cl. 43/15

(57) ABSTRACT

Two pieces of wire segments and a spring adjoined by wire forms that operate as jig for fishing and or set for a hook setting action. Potential energy from the compressed spring is released by an outside force causing the trigger wire loop to leave off resting position on the base wire bottom elongated loop returning kinetic energy motion of spring and trigger wire back to stop base wire loop, thus setting the hook with a jig action, hooking the fish.

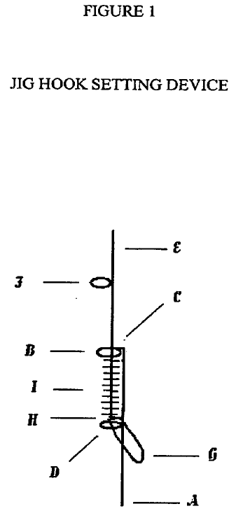

### DESCRIPTION

Two segments of wire adjoined by wire bending forms and a spring that operates as a jig hook setting device.

(E) the base wire segment has a (g) elongated loop at the bottom of one end and is secured by two and one half wraps (h), next (g) the bottom elongated is bent at 22 upward at the same outside circumference of the trigger wire loop (b), next the spring is threaded on the base wire (e) segment butting against the bottom coil wraps (h), next the second segment of wire (c) being the trigger wire is formed with one and half coil wraps one half times larger than the base wire (b) in a clockwise direction, next a 90 degree bend formed at the same distance of the outside circumference of the trigger loop (b), then a 360 degree loop is formed on the trigger wire (a) at half the length of the spring, then threaded on the base wire butting against the top of the spring (l) and through the bottom elongated loop (g), then pulling both the trigger wire (a) and the base wire (e) apart compressing the spring (l) so that you can rest the trigger loop (d) inside the bottom elongated loop (g), next to form a 360 degree loop (f) on the base wire (e) where the end top spring (l) rested in an uncompressed state providing a stopping point and to hold the spring in place for repeated usage, the two end segments are to be used for multiple accessories or just formed into two eyelets to be on your fishing line above any tackle.

What is claimed is:

1. A jig hook setting devise that consist of two segments of wire adjoined by wire formed loop, wraps, and bends securing a spring in place for jigging in it's relaxed position as to pull both ends apart to a compressed position resting the trigger loop inside the base wire elongated loop until an outside force disturbs the device changing potential energy into kinetic energy setting the hook in the fishes mouth. With the ability to add fishing accessories like slip bobbers, hooks, spinners, beads, clevis, lead weights, and artificial lures as well bait for all types of fishing fresh and salt water applications.
